(19) United States
(12) Patent Application Publication
(10) Pub. No.: US 2012/0120770 A1
(43) Pub. Date: May 17, 2012

(54) ALARM CLOCK AND ALARM SHUTDOWN METHOD THEREOF

(75) Inventor: YU-LUN LI, Taoyuan (TW)

(73) Assignee: FOXCONN COMMUNICATION TECHNOLOGY CORP., Taoyuan County (TW)

(21) Appl. No.: 13/080,674

(22) Filed: Apr. 6, 2011

(30) Foreign Application Priority Data
Nov. 16, 2010 (TW) 99139264

(51) Int. Cl. G04G 13/02

(52) U.S. Cl. 368/10

(57) ABSTRACT

In a face recognition-based method for an alarm clock, an alarm time of an alarm clock and a predetermined time period are received from a user and saved in the alarm clock. Upon detecting that a current time matches the alarm time, the alarm clock executes an alarm and directs a capture unit to capture at least one image of the user. If the least one image captured from the capture unit includes an open-eye image and the open-eye image exists after the predetermined time period, the alarm clock turns off the alarm automatically.

### BACKGROUND

1. Technical Field

Embodiments of the present disclosure relate to alarm clocks, and more particularly to a face recognition-based alarm shutdown method and an alarm clock thereof.

2. Description of Related Art

Various alarm clocks typically provide an alarm function. However, users may return to sleep after using a control to shut down an initial or primary alarm of the alarm clocks. This can cause the users to oversleep. What is needed, therefore, is an alarm shutdown method to overcome the limitations described.

### BRIEF DESCRIPTION OF THE DRAWINGS

FIG. 1 is a block diagram of one embodiment of an alarm clock.

FIG. 2 is a flowchart of one embodiment of an alarm shutdown method for an alarm clock.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module” as used herein, refers to logic embodied in hardware or firmware, or to a collection of software instructions, written in a programming language, such as, for example, Java, C, or Assembly. One or more software instructions in the module may be embedded in firmware, such as an EPROM. It will be appreciated that module may comprise connected logic units, such as gates and flip-flops, and may comprise programmable units, such as programmable gate arrays or processors. The module described herein may be implemented as either software and/or hardware module and may be stored in any type of computer-readable medium or other computer storage device.

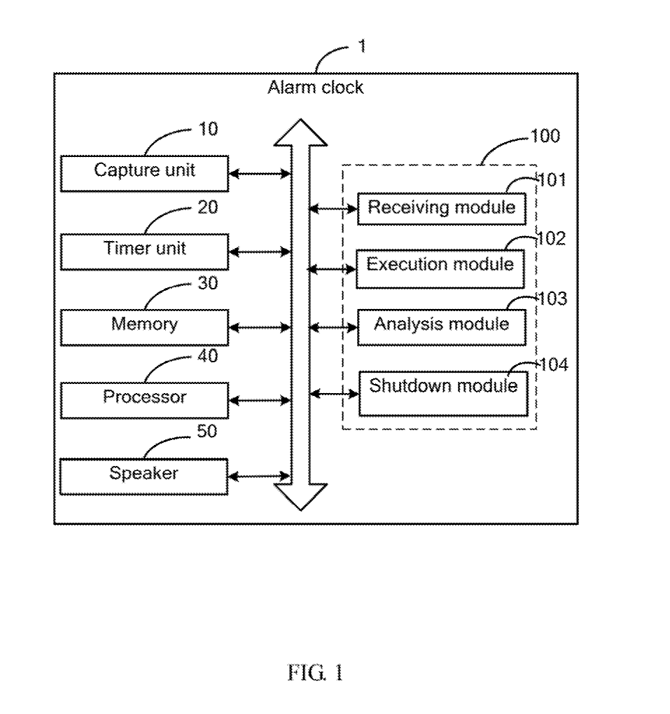

FIG. 1 is a block diagram of one embodiment of an alarm clock 1. The alarm clock 1 includes a system 100, a capture unit 10, a timer unit 20, a memory 30, at least one processor 40, a speaker 50, and one or more programs including a receiving module 101, an execution module 102, an analysis module 103, and a shutdown module 104.

The capture unit 10 is a digital camera module that is operable to capture an image, such as a still image of the user. In addition, the capture unit 10 can also include a video camera module that can capture a video clip or a still image. If a video clip is captured by the video camera module, the at least one processor 40 can perform sampling to generate a number of still images from the video clip.

The timer unit 20 is operable to determine whether a current time matches an alarm time. In addition, the timer unit 20 determines whether an open-eye image exists after a predetermined time period. The open-eye image is an image of opening eye of the user. In one embodiment, if the current time matches the alarm time, and the timer unit 20 implements an alarm of the alarm clock 1.

The memory 30 is electronically connected to the capture unit 10, the timer unit 20, the at least one processor 40, the speaker 50, the receiving module 101, the execution module 102, the analysis module 103 and the shutdown module 104. The memory 30 is operable to store many kinds of data, such as images captured from the capture unit 10, a customization function code of the alarm clock 1, computerized codes of the system 100, programs of an operating system and other applications of the alarm clock 1. The memory 30 may include flash memory, RAM, ROM, cache, or other storage media.

The modules 101-104 may comprise computerized code in the form of one or more programs that are stored in the memory 30. The computerized code includes instructions executed by the at least one processor 40 to provide functions for modules 101-104. The at least one processor 40, as an example, may include a CPU, math coprocessor, or shift register, for example.

The speaker 50 is operable to sound the alarm. In one embodiment, the at least one processor 40 can transform an audio file into an analog signal to the speaker 50. Accordingly, the speaker 50 sounds the alarm.

The receiving module 101 is operable to set the alarm time of the alarm clock 1. In one embodiment, if the current time matches the alarm time, the alarm clock 1 executes the alarm.

In addition, the receiving module 101 is also operable to set the predetermined time period to determine whether the open-eye image exists after the predetermined time period. In other embodiments, the receiving module 101 sets the predetermined time period equal to 30 seconds. For example, the capture unit 10 captures one more image of the user at 30 seconds after the prior captured image. The one more captured image is then sent to the analysis module 103 for analysis.

The execution module 102 is operable to execute the alarm upon determining that the current time matches the alarm time. In addition, upon determining that the current time matches the alarm time, the execution module 102 further directs the capture unit 10 to capture the image of the user to save in the memory 30. In addition, the execution module 102 directs the capture unit 10 to capture the one more image of the user when the current time equals to the predetermined time period after the prior captured image.

The analysis module 103 is operable to determine whether the image includes the open-eye image. Accordingly, the analysis module 103 reads the image from the memory 30 then analyzes the image. In one embodiment, the analysis module 103 detects a facial zone of the user from the image captured from the capture unit 10.

Specifically, the detection of the facial zone can be accomplished by a skin-color algorithm. That is, the facial zone is defined according to a range of skin colors of the user's face. The range of the skin color is disclosed as:

$${Skin}_{color} ( x , y ) = \{ \begin{matrix}1 , & if [ Cr ( x , y ) ∈ {Skin}_{Cr} ] ⋂ [ Cb ( x , y ) ∈ {Skin}_{Cb} ] \\ 0 , & otherwise\end{matrix}$$

where, if the value of Skin_{color} (x, y) is 1, the detected range of the face color is determined as the skin color. The analysis module 103 then sets the color of the detected range as white. If the value of Skin_{color} (x, y) is not 1, the detected range of the face color is determined as being a non-skin color. The analysis module 103 then sets the color of the detected range as black. After defining the facial zone, the analysis module 103 defines a face-rectangular representative of a maximal of the facial zone. The face-rectangular is a sampling space of characteristics within the facial zone which is defined by the analysis module 103 according to the characteristics within the facial zone.

Accordingly, the analysis module 103 is further configured to locate an eye area (that is, an area of the eyes of a user) from the defined facial zone. Firstly, the analysis module 103 locates a rough eye area by detecting two circular shapes having deeper color than a neighborhood from the defined facial zone. After detecting the rough eye area, the analysis module 103 utilizes an algorithm, such as the Sobel algorithm, to enhance the border of the eye area and further darken the eye area. The eye area is then processed by a binarization process. Herein, the binarization process is an image binarizing algorithm based on a mathematical morphology.

After performing the binarization process, the analysis module 103 samples the border of the eye area so as to obtain an outline of the eye area using an algorithm, such as the Snake algorithm. The outline of the eye area is then utilized to define an eye-rectangular representative of a maximal of the eye area, and thus the analysis module 103 may obtain a height (H) and a width (W) of the eye-rectangular.

The analysis module 103 then calculates the ratio of the height and the width of the eye area (H/W), and determine whether the user is awake. In one embodiment, if the ratio of H/W exceeds a threshold value, the analysis module 103 determines that the user is awake. If the ratio of H/W is smaller than the threshold value, the analysis module 103 determines that the user is asleep. Usually, the threshold value is preset by the manufacturer.

The shutdown module 104 is operable to disable the alarm upon determining that the image includes the open-eye image exists after the predetermined time period. For example, if the analysis module 103 detects the open-eye image exists after 30 seconds, the shutdown module 104 disables the alarm.

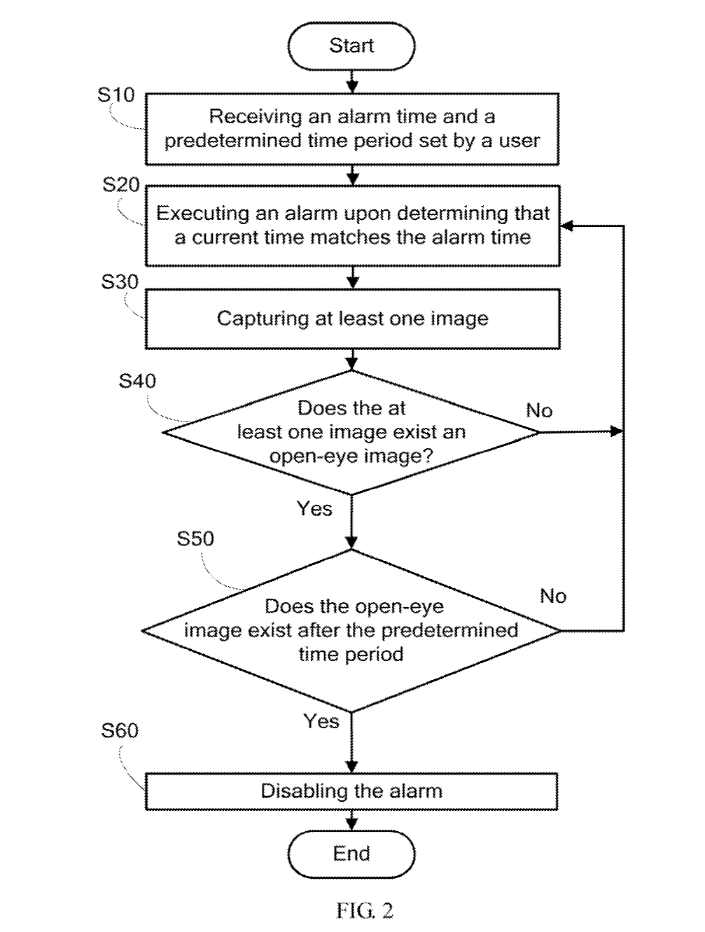

FIG. 2 is a flowchart of one embodiment of an alarm shutdown method for an alarm clock 1. Depending on the embodiment, additional blocks may be added, others deleted, and the ordering of the blocks may be changed.

In block S10, the receiving module 101 receives an alarm time and a predetermined time period set by a user. For example, the user can set the alarm time at 06:20 AM and the predetermined time period to 30 seconds.

In block S20, the execution module 102 executes an alarm upon determining that the current time matches the alarm time.

In block S30, upon determining that the current time matches the alarm time, the execution module 102 further directs the capture unit 10 to capture an image. In one embodiment, the capture unit 10 captures at least one image of the user.

In block S40, the analysis module 103 determines whether the image includes an open-eye image. If the image includes the open-eye image, block S50 is implemented. If the image does not include the open-eye image, block S20 is repeated.

In block S50, upon determining that the image includes the open-eye image, the timer unit 20 determines whether the open-eye image exists after the predetermined time period. In one embodiment, upon determining that the current time equals to 6:20:30 AM, the execution module 102 directs the capture unit 10 to capture one more image of the user. The analysis module 103 then determines whether the new image of the user includes the open-eye image. If the open-eye image exists after the predetermined time period, block S60 is implemented. If the open-eye image does not exist after the predetermined time period, block S20 is repeated.

In block S60, the shutdown module 104 shuts down the alarm upon determining that the image includes the open-eye image exits after the predetermined time period.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. An alarm clock, comprising:
a capture unit operable to capture an image;
a timer unit operable to determine whether a current time matches an alarm time of the alarm clock;
a memory;
at least one processor;
a speaker;
one or more programs that are stored in the memory and are executed by the at least one processor, the one or more programs comprising:
a receiving module operable to set the alarm time and a predetermined time period;
an execution module operable to execute an alarm using the speaker upon determining that the current time matches the alarm time;
an analysis module operable to determine whether the image includes an open-eye image; and
a shutdown module operable to disable the alarm upon determining that the image includes the open-eye image that exists after the predetermined time period.

2. The alarm clock of claim 1, wherein the execution module further directs the capture unit to capture one more image of the user upon determining that the current time equals to the predetermined time period after a prior captured image.

3. The alarm clock of claim 1, wherein the capture unit is a video camera module.

4. The alarm clock of claim 1, wherein the capture unit is a digital camera module.

5. The alarm clock of claim 1, wherein the alarm time and the predetermined time period is saved in the memory.

6. A alarm shutdown method for an alarm clock, the alarm clock comprising a capture unit, a memory and at least one processor, the method comprising:
receiving an alarm time of the alarm clock and a predetermined time period set by a user;
executing an alarm upon determining that current time matches the alarm time;
capturing at least one image of the user by the capture unit;
determining whether the at least one image includes an open-eye image;
determining whether the open-eye image that exists after the predetermined time period if the at least one image includes the open-eye image; and
disabling the alarm upon determining that the open-eye image exists after the predetermined time period.

7. The method of claim 6, wherein the executing step executes the alarm using a speaker.

8. The method of claim 6, wherein the capturing step captures the at least one image by a video camera module.

9. The method of claim 6, wherein the capturing step captures the at least one image by a digital camera module.

10. The method of claim 6, further comprising saving the alarm time and the predetermined time period in the memory.

11. A storage medium having stored thereon instructions that, when executed by a processor, causes the processor to perform a alarm shutdown method for an alarm clock, the alarm clock comprising a capture unit, a memory and at least one processor, the method comprising:
receiving an alarm time of the alarm clock and a predetermined time period set by a user;
executing an alarm upon determining that current time matches the alarm time;
capturing at least one image of the user by the capture unit;
determining whether the at least one image includes an open-eye image;
determining whether the open-eye image that exists after the predetermined time period if the at least one image includes the open-eye image; and
disabling the alarm upon determining that the open-eye image exists after the predetermined time period.

12. The storage medium of claim 11, wherein the executing step executes the alarm using a speaker.

13. The storage medium of claim 11, wherein the capturing step captures the at least one image by a video camera module.

14. The storage medium of claim 11, wherein the capturing step captures the at least one image by a digital camera module.

15. The storage medium of claim 11, wherein the method further comprising saving the alarm time and the predetermined time period in the memory.
